(19) United States
(12) Patent Application Publication
(10) Pub. No.: US 2023/0200292 A1
(43) Pub. Date: Jun. 29, 2023

(54) MODULAR CONTROL-TYPE PLANT CULTIVATION DEVICE

(71) Applicant: AG-UNI CO., LTD, Gyeongsan-si (KR)

(72) Inventor: Mi Jin GWON, Gyeongsan-si (KR)

(73) Assignee: AG-UNI CO., LTD, Gyeongsan-si (KR)

(21) Appl. No.: 17/922,273

(22) PCT Filed: Dec. 8, 2020
(86) PCT No.: PCT/KR2020/017804

§ 371 Date: Oct. 28, 2022

(30) Foreign Application Priority Data
Sep. 18, 2020 (KR) 10-2020-0120884

(51) Int. Cl. A01C 23/02; A01C 23/04

(52) U.S. Cl. CPC A01C 23/023; A01C 23/042

(57) ABSTRACT

According to an embodiment of the present invention, there is provided a plant cultivation device, including: a body part configured such that a growth space in which a soil and plants are accommodated and to which a nutrient solution is supplied and an auxiliary space which is disposed under the growth space, into which air is introduced and through which a nutrient solution supplied to the soil is discharged are formed therein; a fertilization part disposed inside the body part and configured to supply a nutrient solution to the soil; and a separation part disposed between the growth space and the auxiliary space, configured to prevent the inflow of the soil into the auxiliary space, and provided with a plurality of openings having a smaller diameter; wherein the air introduced into the auxiliary space is introduced into the soil through the openings and promotes the growth of the plants.

### TECHNICAL FIELD

The present invention relates to a plant cultivation device having a structure in which air and a nutrient solution can be supplied simultaneously.

### BACKGROUND ART

Recently, the size of the smart farm market in which AI or big data technology according to the fourth industrial field is combined to enable agricultural systems to be used efficiently is increasing. A smart farm is an expanded concept for a plant cultivation device or a plant factory, and refers to an advanced agricultural form that improves the productivity and quality of agricultural products by applying ICT technology, such as the Internet of Things, or BT technology to facility horticulture.

The sizes of the smart farm support projects and market in Korea and abroad are increasing every year. In Korea, it is expected that the size has grown from KRW 4.4493 trillion in 2017 to KRW 5.9588 trillion in 2022 at an average annual rate of 5%. It can be seen that the size of the global market has also grown by more than 5% annually.

In particular, in the case of Korea, the government or public institutions are actively supporting smart farm-related support projects. In fact, the Rural Development Administration of Korea is promoting the development of smart farm technology in three stages for the purpose of efficient technology development and rapid popularization as of 2015. Remote monitoring and control technology, which is the first-generation technology, has already been developed, and intelligent precision growth management technology, which is the second-generation technology, is currently being developed. This project aims to export technology through the development of Korean-style smart farm technology in the following three steps. In addition, the development and popularization of Korean domestic smart farm technology are being carried out as in the case where individual local governments has decided to install smart farm innovation valleys in four locations across the country.

However, in order for such smart farm technology to be implemented normally, a plant cultivation device for the growth of plants is the most important and essential means. A plant cultivation device is a means capable of providing a space in which plants can be grown, e.g., a space in which a soil and plants are accommodated in the case of soil cultivation or a space in which a nutrient solution is accommodated in the case of hydroponics. However, the conventionally provided plant cultivation devices have the following problems.

First of all, in the case of a plant cultivation device for soil cultivation, there is a problem in that a manager must directly spray a nutrient solution onto a soil in order to promote the growth of plants because there is no separate means for supplying a nutrient solution to plants in the state where a soil is accommodated.

As a solution to the above problem, there is provided a plant cultivation device in which a spray pipe for supplying a nutrient solution is disposed in the upper part of a space, in which a soil is accommodated, and can uniformly supply a nutrient solution to the soil. However, even in this case, there is a problem that a nutrient solution cannot be uniformly supplied to the inside of the soil and the nutrient solution is not supplied to the roots of plants.

In addition, in the case of soil cultivation, there is a problem in that the roots of plants remain buried in a soil, so that oxygen for root respiration does not come into contact with the roots and thus root respiration is not performed appropriately, thereby slowing the growth of the plants.

In contrast, in the case of a plant cultivation device for hydroponics, the roots of plants are directly immersed in a nutrient solution, so that the supply of nutrients is smoothly performed, but there are problems in that the types of crops that can be cultivated through hydroponics are limited and, in particular, it is impossible to supply oxygen to the roots for root respiration.

Therefore, for the development of the smart farm industry, there is an urgent need to develop a plant cultivation device for supplying a nutrient solution and supplying oxygen for root respiration smoothly.

### PRIOR ART LITERATURE

### Patent Document

Korean Utility Model Registration Application No. 20-2014-0001904 (Title of the Invention: Plant Cultivation Equipment and Plant Cultivation Method)

### DISCLOSURE

### Technical Problem

The present invention has been conceived to overcome the above-described problems, and an object of the present invention is to provide a plant cultivation device capable of uniformly supplying a nutrient solution to the roots of plants and, simultaneously, supplying oxygen, i.e., air, for root respiration.

The objects of the present invention are not limited to the above-described object, and another object may be derived from the following description.

### Technical Solution

According to an embodiment of the present invention, there is provided a plant cultivation device, including: a body part configured such that a growth space in which a soil and plants are accommodated and to which a nutrient solution is supplied and an auxiliary space which is disposed under the growth space, into which air is introduced and through which a nutrient solution supplied to the soil is discharged are formed therein; a fertilization part disposed inside the body part and configured to supply a nutrient solution to the soil; and a separation part disposed between the growth space and the auxiliary space, configured to prevent the inflow of the soil into the auxiliary space, and provided with a plurality of openings having a diameter smaller than or equal to a set size;

wherein the air introduced into the auxiliary space is introduced into the soil through the openings and promotes the growth of the plants.

Furthermore, the body part includes: a case part configured such that the growth space and the auxiliary space are formed therein; a nutrient solution inlet formed on one side of the growth space of the case part, and configured to receive the nutrient solution supplied from the fertilization part; and an air inlet formed on one side of the auxiliary space of the case part, and configured to introduce the air into the auxiliary space.

Furthermore, the fertilization part includes: a first fertilization part connected to the nutrient solution inlet, disposed to surround the sides of the growth space, and provided with a plurality of spray holes; and a second fertilization part disposed to extend downward from the first fertilization part, disposed to surround the sides of the growth space, and provided with a plurality of spray holes.

Furthermore, the growth space includes: a first growth space formed downward from the upper end of the case part by a set length; and a second growth space formed from the lower end of the first growth space to the lower end of the case part, and configured such that the soil is disposed therein; wherein the first fertilization unit is disposed in the first growth space and supplies a nutrient solution to the outside of the soil, and the second fertilization unit is disposed in the second growth space and supplies a nutrient solution to the inside of the soil.

Furthermore, the fertilization part includes: a nutrient solution passage configured to form a flow path through which a nutrient solution is supplied, and provided with a plurality of spray holes; and a passage protection part formed to surround the outside of the nutrient solution passage, and provided with a plurality of openings having a diameter smaller than or equal to a set size.

According to another embodiment of the present invention, there is provided a plant cultivation system, including: the plant cultivation device according to claim 2; a nutrient solution supply unit configured to mix and supply a nutrient solution; a water supply unit configured to supply the nutrient solution to the nutrient solution inlet; and an air supply unit configured to supply air to the air inlet.

Moreover, the nutrient solution supply unit includes: at least one nutrient solution storage part configured to store a nutrient solution; a water storage part configured to store water; and a mixed solution storage part configured such that the nutrient solution stored in the nutrient solution storage part and the water stored in the water storage part are mixed together therein.

### Advantageous Effects

According to the plant cultivation device according to an embodiment of the present invention configured as described above, there are the following effects:

The plant growth space in which the roots of plants can be supplied with a nutrient solution in the state of being buried in the soil and the auxiliary space in which air is supplied to the roots of the plants are separated from each other by the separation part, so that there is an effect in that a nutrient solution and air can be supplied to the roots of plants simultaneously.

Furthermore, the fertilization part is disposed such that a nutrient solution can be supplied from the outside of the soil of the plant growth space and the inside of the soil, so that there is an effect in that a nutrient solution can be uniformly supplied to the soil in the plant cultivation device.

Moreover, the amount of air retained by the soil in the plant growth space is increased by supplying air to the plant soil at a constant pressure, so that there is an effect in that oxygen is efficiently supplied to the roots of plants.

### DESCRIPTION OF DRAWINGS

FIG. 1 is a diagram showing the configuration of a plant cultivation system in which a plant cultivation device according to an embodiment of the present invention is utilized;

FIG. 2 is a front perspective view of the state in which a soil is accommodated in a plant cultivation device according to an embodiment of the present invention;

FIG. 3 is a front perspective view of the state in which a soil is not accommodated in the plant cultivation device according to the embodiment of the present invention;

FIG. 4 is a rear perspective view of the plant cultivation device according to the embodiment of the present invention;

FIG. 5 is a perspective view of the plant cultivation device according to the embodiment of the present invention except for a body part; and

FIG. 6 is a side sectional view of the plant cultivation device according to the embodiment of the present invention.

### MODE FOR INVENTION

An embodiment of the present invention relates to a plant cultivation device 200 that can uniformly supply a nutrient solution and oxygen to the roots of plants by uniformly supplying the nutrient solution to the inside of the soil L in which the plants are accommodated while supplying air into a soil L. Hereinafter, it will be briefly referred to as a “plant grower 200.”

Furthermore, a mixed solution, in which a nutrient solution and water are mixed together, to be described below may include a case in which the nutrient solution is supplied alone, so that the mixed solution to be described below is defined as the nutrient solution in the claims.

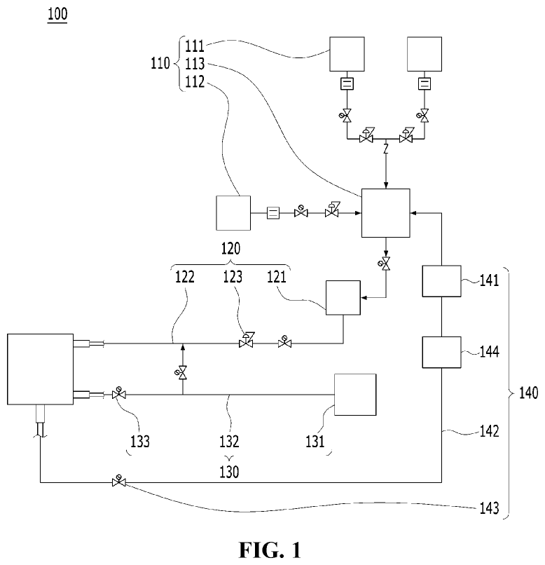

FIG. 1 is a diagram showing the configuration of a plant cultivation system in which a plant cultivation device according to an embodiment of the present invention is utilized.

Referring to FIG. 1, first, the overall structure of a plant cultivation system 100, in which a plant cultivation device 200 according to an embodiment of the present invention is used, will be described. The plant cultivation system 100 is a system that can supply a nutrient solution and oxygen to the roots of plants by using the plant cultivation device 200. The plant cultivation system 100 may include: a nutrient solution supply unit 110 configured to provide a nutrient solution to be supplied to plants; a water supply unit 120 configured to supply a nutrient solution, supplied from the nutrient solution supply unit 110, to the plant cultivation device 200; an air supply unit 120 configured to supply air to the plant cultivation device 200; a drainage unit 140 configured to discharge a nutrient solution supplied to the plant cultivation device 200; and the plant cultivation device 200 configured to provide a space for the cultivation of plants and to be supplied with a nutrient solution and air from the water supply unit 120 and the air supply unit 120, respectively.

The nutrient solution supply unit 110 is a means for supplying a nutrient solution for the supply of nutrients necessary for the growth of plants. In detail, the nutrient solution supply unit 110 includes a nutrient solution storage part 111 configured to store at least one nutrient solution, a water storage part configured to store water for the control of the concentration of the nutrient solution to be supplied to plants, and a mixed solution storage part 113 configured to store a mixed solution in which the water of the water storage part and the nutrient solution of the nutrient solution storage part 111 are mixed together. There is an effect in that a manager can determine the ratio between the various nutrient solutions of the nutrient solution storage part 111 and the water of the water storage part 112 according to the type of plants to be grown and then store a mixed solution having the determined ratio in the mixed solution storage part 113.

The water supply unit 120 is a means for supplying the mixed solution, stored in the mixed solution storage part 113, to the plant cultivation device 200. In detail, the water supply unit 120 may include: a water supply pump 121 configured to provide power for the supply of a mixed solution to the plant cultivation device 200; a water supply passage 122 configured to provide a flow pass through which the mixed solution supplied from the water supply pump 121 flows; and a water supply valve 123 configured to selectively open and close the supply passage. Through this configuration, when desired, a manager may determine whether to supply the mixed solution to the plant cultivation device 200 by turning the water supply valve 123 on or off.

The air supply unit 120 may include: an air pump 121 configured to provide power for the supply of external air to the plant cultivation device 200; an air passage 122 configured to provide a flow path through which the air supplied from the air pump 121 flows; and an air valve 123 configured to selectively open and close the air passage 122. Through this configuration, when desired, a manager may determine whether to supply the air to the plant cultivation device 200 by turning the air valve 123 on or off.

The drainage unit 140 is a means through which a mixed solution remaining after being supplied to the plants in the plant cultivation device 200 can be discharged to the outside. In detail, the drainage unit 140 may include: a drain pump 141 configured to provide power for the discharge of a mixed solution remaining after being supplied to plants; a drain passage 142 configured to provide a flow path through which the mixed solution discharged from the drain pump 141 flows; a drain valve 143 configured to selectively open and close the drain passage 142; and a filter part 144 configured to screen the mixed solution passing through the drain passage 142 by filtering it. The mixed solution discharged through the drainage unit 140 may be filtered and supplied back to the nutrient solution supply unit 110.

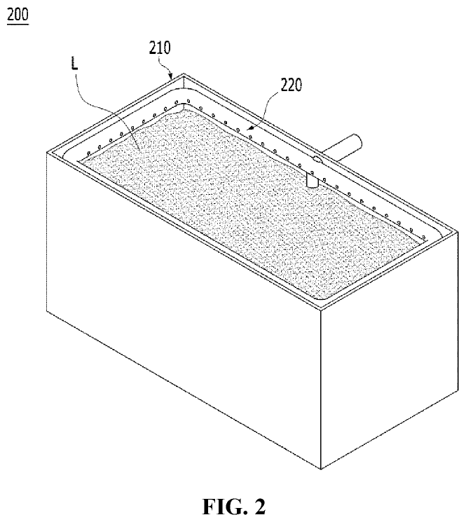

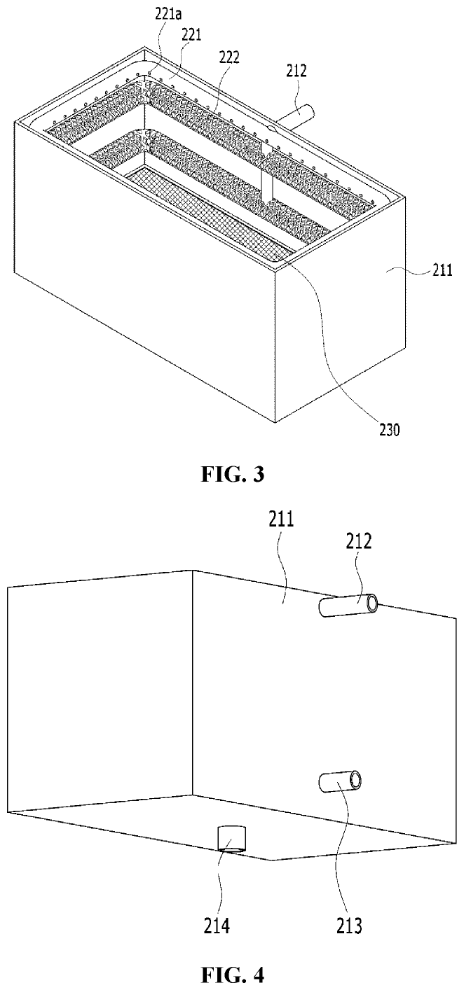

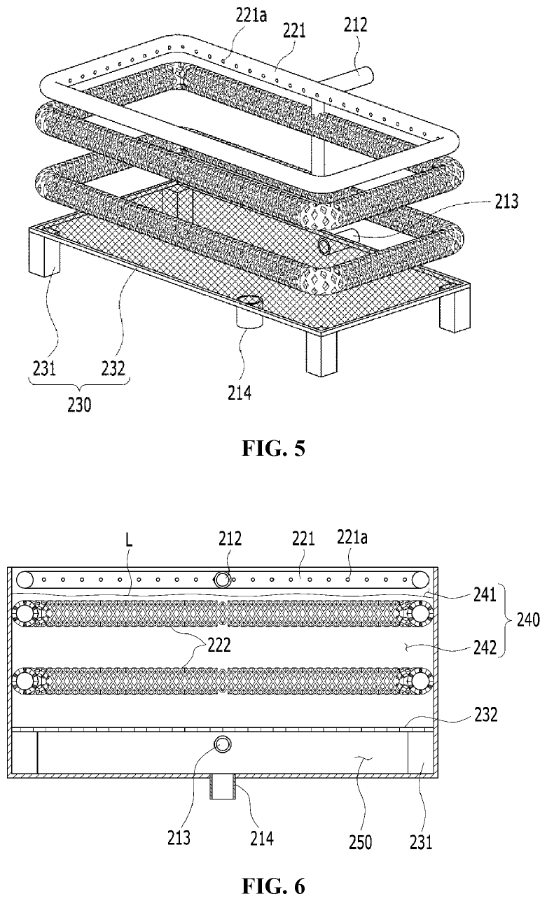

FIG. 2 is a front perspective view of the state in which a soil L is accommodated in a plant cultivation device according to an embodiment of the present invention, FIG. 3 is a front perspective view of the state in which a soil L is not accommodated in the plant cultivation device according to the embodiment of the present invention, FIG. 4 is a rear perspective view of the plant cultivation device according to the embodiment of the present invention, FIG. 5 is a perspective view of the plant cultivation device according to the embodiment of the present invention except for a body part, and FIG. 6 is a side sectional view of the plant cultivation device according to the embodiment of the present invention.

Referring to FIGS. 2 to 6, the plant cultivation device 200 is a means for providing a space for the cultivation of plants, receiving a mixed solution, generated by the nutrient solution supply unit 110, from the water supply unit 120, receiving air from the air supply unit 120, and providing them to plants. In detail, the plant cultivation device 200 may include: a body part 210 configured such that a growth space 240 in which a soil L and plants are accommodated and to which a nutrient solution is supplied and an auxiliary space 250 which is disposed under the growth space 240, into which air is introduced and through which a nutrient solution supplied to the soil L is discharged are formed therein; a fertilization part 220 disposed inside the body part 210 and configured to supply a nutrient solution to the soil L; and a separation part 230 disposed between the growth space 240 and the auxiliary space 250, configured to prevent the inflow of the soil L into the auxiliary space 250, and also provided with a plurality of openings having a diameter smaller than or equal to a set size. The above individual components will be described in detail below.

The body part 210 may include: a case part 211 configured such that the growth space 240 and the auxiliary space 250 are formed therein; a nutrient solution inlet 212 formed on one side of the growth space 240 of the case part 211 and configured to receive the nutrient solution supplied from the fertilization part 220, i.e., a mixed solution; an air inlet 213 formed on one side of the auxiliary space 250 of the case part 211 and configured to receive the air supplied from the air supply unit 120; and a drain hole 214 configured to drain a mixed solution remaining after being supplied to plants.

The case part 211 may have, e.g., a rectangular box shape, and the inner space of the case part 211 may be divided into the upper growth space 240 and the lower auxiliary space 250 by the separation part 230. In this case, the fertilization part 220 and the separation part 230 may be disposed inside the case part 211. In this case, the growth space 240 refers to a space in which the soil L is disposed and plants can be planted and grown in the soil L, and the auxiliary space 250 refers to a space which is formed as a separate empty space below the growth space 240 and into which air can be introduced or a mixed solution remaining after being supplied to the plants in the growth space 240 can be discharged.

In addition, the growth space 240 may be divided into a first growth space 241 which provides a space for the growth of plants over the soil L and a second growth space 242 which is a space filled with soil L under the first growth space 241. The first growth space 241 and the second growth space 242 are means that are defined for the arrangement of the fertilization part 220 to be described later.

The nutrient solution inlet 212 may be connected to the water supply passage 122 of the water supply unit 120, and may provide an opening through which a mixed solution flowing in the water supply passage 122 can be introduced into the growth space 240. Similarly, the air inlet 213 may be connected to the air passage 122 of the air supply unit 120, and may provide an opening through which air flowing through the air passage 122 can be introduced into the auxiliary space 250. In other words, a nutrient solution (a mixed solution) and air may be supplied to the growth space 240 and the auxiliary space 250 through the nutrient solution inlet 212 and the air inlet 213, respectively.

In addition, the drain hole 214 may be connected to the drain passage 142 of the drainage unit 140, and may provide an opening through which a mixed solution remaining after being supplied to plants can be introduced back into the mixed solution storage part 141.

The fertilization part 220 is a means that is connected to the nutrient solution inlet 212 and supplies a mixed solution, introduced through the nutrient solution inlet 212, to the growth space 240. The fertilization part 220 may include: a nutrient solution passage configured to provide a flow path through which a mixed solution introduced from the nutrient solution inlet 212 can flow, and provided with a plurality of spray holes through which a mixed solution can be sprayed to the outside; and a passage protection part formed to surround the outside of the nutrient solution passage, and provided with a plurality of openings having a diameter smaller than or equal to a set size.

The nutrient solution passage is a means which has a circular cross section and is formed to surround the inner surface of the case part 211 and through which a mixed solution to be sprayed into the growth space 240 can flow. Furthermore, there is an effect in that as the plurality of spray is formed inside the nutrient solution passage, a mixed solution can be uniformly sprayed into the growth space 240.

The passage protection part may be formed to surround the outside of the nutrient solution passage, and may be provided with the plurality of openings having the diameter smaller than or equal to the set size. In this case, the plurality of openings may have a size smaller than the sizes of the grains of the soil L, through which there are effects in that a problem, in which the soil L or foreign materials disposed in the growth space 240 are introduced into the spray holes of the nutrient solution passage and block the spraying of a mixed solution, can be overcome and in that a mixed solution sprayed through the spray holes of the nutrient solution passage can be efficiently supplied to the growth space 240.

In addition, the fertilization part 220 may include a first fertilization part 221 disposed in the first growth space 241 and a second fertilization part 222 disposed in the second growth space 242, according to the arrangement area thereof.

In detail, the first fertilization part 221 is connected from the nutrient solution inlet 212 and disposed on the upper side of the fertilization part 220, so that a mixed solution can be sprayed into the first growth space 241 where the soil L is not disposed. In this case, the mixed solution is supplied to wet the surface of the soil L and serves to constantly control the humidity of the surface of the soil L. Furthermore, the first fertilization part 221 may be disposed to surround the sides of the growth space 240, specifically the first growth space 241.

In addition, the second fertilization part 222 may be disposed to extend downward from one side of the first fertilization part 221, and may be buried and disposed in the soil L of the second growth space 242. Accordingly, as a mixed solution introduced from the nutrient solution inlet 212 is directly sprayed into the soil L from the spray holes of the second fertilization part 222 through the first fertilization part 221, it plays a role in maintaining a constant humidity inside the soil L. Furthermore, the second fertilization part 222 may be disposed to surround the sides of the growth space 240, specifically the second growth space 242.

In this case, the passage protection part of the fertilization part 220 may be disposed only in the second fertilization part 222. The reason for this is that there is no need to protect a nutrient solution flow path unless it is directly buried in the soil L, as in the first fertilization part 221.

In other words, the fertilization part 220 may include the first fertilization part 221 disposed outside the soil L (in the first growth space 241) and the second fertilization part 222 disposed inside the soil L (in the second growth space 242), so that there is an effect in that a mixed solution can be simultaneously supplied to the surface and inside of the soil L.

The separation unit 230 is a means that may be disposed inside the body part 210 and separate the space in the body part 210 into the growth space 240 and the auxiliary space 250. In detail, the separation unit 230 may include one or more protrusion parts 231 protruding by the height of the auxiliary space 250 and a separation plate 232 disposed at the top ends of the protrusion parts 231 and having the same size as the top surface of the body part 210. In this case, the protrusion parts 231 are disposed at four corners of the separation plate 232, so that the separation plate 232 may be spaced apart from the bottom surface of the case part 211 by the height of the auxiliary space upward.

In addition, a plurality of openings smaller than or equal to a set size may be formed in the separation plate 232. The reason for this is to prevent the soil L disposed above the separation plate from entering the auxiliary space 250 and to allow a mixed solution supplied to plants to flow into the auxiliary space 250.

The separation part 230 may form a space into which air is introduced from the auxiliary space 250, i.e., the air inlet 213, or to which a mixed solution remaining after being supplied in the growth space 240 is discharged. The auxiliary space 250 may be disposed under the separation part 230 as an empty space, and a mixed solution may be discharged or air may be supplied through the auxiliary space 250.

The operation of the plant cultivation device 200 according to the embodiment of the present invention will be described below.

First, when a nutrient solution, i.e., a mixed solution, is supplied from the nutrient solution supply unit 110, the supplied mixed solution may be introduced into the fertilization part 220 via a nutrient solution supply hole through the water supply unit 120. The mixed solution introduced into the fertilization part 220 is sprayed into the first growth space 241 and then onto the surface of the soil L by the spray holes formed in the first fertilization part 221 in the process of moving downward inside the fertilization part 220 due to gravity. Furthermore, the mixed solution moved downward may be sprayed into the second growth space 242 and then into the inside of the soil L by the spray holes formed in the second fertilization part 222. Accordingly, there is an effect in that the mixed solution can be evenly sprayed to the surface and inside of the soil L.

In addition, a mixed solution may be supplied from the nutrient solution supply unit 110 and, simultaneously, air may be supplied from the air supply unit 120. In detail, the air supplied from the air supply unit 120 may be introduced into the auxiliary space 250 through the air supply hole. In this case, as the drain valve 143 is turned off for a set time and closes the drain passage 142, the auxiliary space 250 can be maintained in a closed state. Accordingly, the introduced air may be supplied into the soil L through the openings of the separation part 230.

According to the above operation, a mixed solution is uniformly supplied to the soil L and, simultaneously, air is evenly supplied between the pores of the soil L, so that a mixed solution and air can be abundantly supplied to the roots of plants growing in the growth space 240, and thus the growth of the plant can be promoted.

According to the plant cultivation device 200 according to the embodiment of the present invention configured as described above, there are the following effects:

The plant growth space 240 in which the roots of plants can be supplied with a nutrient solution in the state of being buried in the soil L and the auxiliary space 250 in which air is supplied to the roots of the plants are separated from each other by the separation part 230, so that there is an effect in that a nutrient solution and air can be supplied to the roots of plants simultaneously.

Furthermore, the fertilization part 220 is disposed such that a nutrient solution can be supplied from the outside of the soil L of the plant growth space 240 and the inside of the soil L, so that there is an effect in that a nutrient solution can be uniformly supplied to the soil L in the plant cultivation device 200.

Moreover, the amount of air retained by the soil L in the plant growth space 240 is increased by supplying air to the plant soil L at a constant pressure, so that there is an effect in that oxygen is efficiently supplied to the roots of plants.

The present invention has been described so far with a focus on the preferred embodiments. It will be understood by those of ordinary skill in the art to which the present invention pertains that the present invention may be implemented in a modified form without departing from the essential characteristics of the present invention. Therefore, the disclosed embodiments should be taken into consideration in an illustrative sense rather than a restrictive sense. The scope of the present invention is defined based on the attached claims rather than the foregoing detailed description, and all differences falling within the scopes equivalent to the claims should be construed as being included in the present invention.

| | |
|---|---|
| 100: plant cultivation system | 110: nutrient solution supply unit |
| 120: water supply unit | 130: air supply unit |
| 140: drainage unit | 200: plant cultivation device |
| 210: body part | 211: case part |
| 212: nutrient solution inlet | 213: air inlet |
| 214: drain hole | 220: fertilization part |
| 221: first fertilization part | 222: second fertilization part |
| 230: separation part | 240: growth space |
| 241: first growth space | 242: second growth space |
| 250: auxiliary space | |

1. A plant cultivation device, comprising:
a body part configured such that a growth space in which a soil and plants are accommodated and to which a nutrient solution is supplied and an auxiliary space which is disposed under the growth space, into which air is introduced and through which a nutrient solution supplied to the soil is discharged are formed therein;
a fertilization part disposed inside the body part and configured to supply a nutrient solution to the soil; and
a separation part disposed between the growth space and the auxiliary space, configured to prevent an inflow of the soil into the auxiliary space, and provided with a plurality of openings having a diameter smaller than or equal to a set size;
wherein the air introduced into the auxiliary space is introduced into the soil through the openings and promotes growth of the plants.

2. The plant cultivation device of claim 1, wherein the body part comprises:
a case part configured such that the growth space and the auxiliary space are formed therein;
a nutrient solution inlet formed on one side of the growth space of the case part, and configured to receive the nutrient solution supplied from the fertilization part; and
an air inlet formed on one side of the auxiliary space of the case part, and configured to introduce the air into the auxiliary space.

3. The plant cultivation device of claim 2, wherein the fertilization part comprises:
a first fertilization part connected to the nutrient solution inlet, disposed to surround sides of the growth space, and provided with a plurality of spray holes; and
a second fertilization part disposed to extend downward from the first fertilization part, disposed to surround sides of the growth space, and provided with a plurality of spray holes.

4. The plant cultivation device of claim 3, wherein the growth space comprises:
a first growth space formed downward from an upper end of the case part by a set length; and
a second growth space formed from a lower end of the first growth space to a lower end of the case part, and configured such that the soil is disposed therein;
wherein the first fertilization unit is disposed in the first growth space and supplies a nutrient solution to an outside of the soil, and the second fertilization unit is disposed in the second growth space and supplies a nutrient solution to an inside of the soil.

5. The plant cultivation device of claim 1, wherein the fertilization part comprises:
a nutrient solution passage configured to form a flow path through which a nutrient solution is supplied, and provided with a plurality of spray holes; and
a passage protection part formed to surround an outside of the nutrient solution passage, and provided with a plurality of openings having a diameter smaller than or equal to a set size.

6. A plant cultivation system, comprising:
the plant cultivation device according to claim 2;
a nutrient solution supply unit configured to mix and supply a nutrient solution;
a water supply unit configured to supply the nutrient solution to the nutrient solution inlet; and
an air supply unit configured to supply air to the air inlet.

7. The plant cultivation system of claim 6, wherein the nutrient solution supply unit comprises:
at least one nutrient solution storage part configured to store a nutrient solution;
a water storage part configured to store water; and
a mixed solution storage part configured such that the nutrient solution stored in the nutrient solution storage part and the water stored in the water storage part are mixed together therein.
